(19) United States
(12) Patent Application Publication
(10) Pub. No.: US 2021/0281938 A1
(43) Pub. Date: Sep. 9, 2021

(54) PORTABLE SPEAKER WITH REMOVABLE INTERFACE

(71) Applicant: ALOHA CORPORATION, Urbandale, IA (US)

(72) Inventor: Srdjan Pavelic, Urbandale, IA (US)

(21) Appl. No.: 17/249,567

(22) Filed: Mar. 5, 2021

Related U.S. Application Data
(60) Provisional application No. 62/986,231, filed on Mar. 6, 2020.

(51) Int. Cl. H04R 1/02; G06F 3/16

(52) U.S. Cl. CPC H04R 1/028; H04R 1/025; H04R 2420/09; H04R 2201/02; G06F 3/162

(57) ABSTRACT

A smart system includes smart device features and power and connectivity components. The system includes a power supply, which allows the smart system to be powered in a wireless manner. This allows the smart system to become portable and untethered. The system also includes a communications module, such as, but not limited to, WiFi, Bluetooth, and/or cellular data. The communications module creates a network for the smart system to connect, which provides inputs for the smart dev system ice. The same or a different communications module allows the smart system to connect to a second or separate output, such as a portable speaker, to provide a portable, smart system to incorporate smart functionality and better audio quality in a portable manner.

### CROSS REFERENCE TO RELATED APPLICATIONS

This application claims priority under 35 U.S.C. § 119 to provisional patent application U.S. Ser. No. 62/986,231, filed Mar. 6, 2020. The provisional patent application is herein incorporated by reference in its entirety, including without limitation, the specification, claims, and abstract, as well as any figures, tables, appendices, or drawings thereof.

### FIELD OF THE INVENTION

The invention relates generally to portable speakers, such as for personal use. More particularly, but not exclusively, the invention relates to methods, systems, and/or apparatus for adapting a portable speaker for use with a portable smart device to provide a user interface and audio source for the portable speaker.

### BACKGROUND OF THE INVENTION

The background description provided herein gives context for the present disclosure. Work of the presently named inventors, as well as aspects of the description that may not otherwise qualify as prior art at the time of filing, are neither expressly nor impliedly admitted as prior art.

Portable speaker systems have been used in the electronics industry to allow users to be increasingly mobile in where and when they are able to enjoy audio listening. For example, stationary speakers are generally confined to their initial placement for a variety of reasons. These include a need of a power supply, weight, size, etc. Portable speakers, however, are generally lighter and smaller in size than a traditional speaker system and may allow a user to play music without a need for connection to power.

Speaker systems are used to project audio. Bluetooth, internet, Wi-Fi, internal storage, radio broadcasting, an auxiliary cord, etc. are examples of ways in which a speaker system can process and stream audio from a music source. In some instances, a smart device, such as a smart speaker, may be used in conjunction with a speaker system. The speaker is able to amplify the audio from the smart device to project the sound better than the smart speaker.

However, smart devices are limited, in that they generally require Wi-Fi or other wireless inputs (local area networks, wide area networks, cellular networks, or the like) to operate, require a tethered power supply, do not provide optimal sound outputs, and are otherwise not portable. These issues, among others, limit the use of smart devices with portable speakers in an on-the-go manner.

Thus, there exists a need in the art for a system, method, and/or apparatus that overcomes the issues of pairing smart devices with a portable speaker for true, portable use.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of any aspects of any embodiments disclosed in the present specification to improve on or overcome the deficiencies in the art.

It is another object, feature, and/or advantage of any aspects of any embodiments disclosed in the present specification to combine a portable speaker with a portable smart device.

It is a further object, feature, and/or advantage of any aspects of any embodiments disclosed in the present specification to make a smart device portable.

It is still another object, feature, and/or advantage of any aspects of any embodiments disclosed in the present specification to provide a portable, connected interface and/or audio input for a speaker.

The apparatus, systems, and/or methods disclosed herein can be used in a wide variety of applications. For example, generally any portable speaker, audio device, fixed speaker, or the like could be incorporated with aspects disclosed to provide a smart interface for accessing generally hands-free usage of the interface combination.

It is preferred the apparatus be safe, cost effective, and durable.

At least one embodiment disclosed herein comprises a distinct aesthetic appearance. Ornamental aspects included in such an embodiment can help capture a consumer's attention and/or identify a source of origin of a product being sold. Said ornamental aspects should not impede functionality of the present invention.

The apparatus, systems, and/or methods disclosed can be incorporated into systems or kits which accomplish some or all of the previously stated objectives.

These and/or other objects, features, advantages, aspects, and/or embodiments will become apparent to those skilled in the art after reviewing the following brief and detailed descriptions of the drawings.

### BRIEF DESCRIPTION OF THE DRAWINGS

FIG. 1 is a perspective view of portable smart system showing a portable smart device with housing according to at least some of the aspects and/or embodiments disclosed.

FIG. 2 is a front planar view of the portable smart system.

FIG. 3 is an exploded view of the portable smart system.

FIG. 4 is a block diagram showing components of a portable smart system according to aspects and/or embodiments disclosed.

FIG. 5 is a perspective view of a housing of a portable smart system according to aspects and/or embodiments disclosed.

FIG. 6 is a front planar view of the housing.

FIG. 7 is a side elevation view of the housing.

FIG. 8 is a perspective view of an exemplary speaker for use with a portable smart system according to aspects and/or embodiments disclosed.

FIG. 9 is a front elevation view of the exemplary speaker.

FIG. 10 is a rear elevation view of the exemplary speaker.

FIG. 11 is top elevation view of the exemplary speaker.

FIG. 12 is a bottom elevation view of the exemplary speaker.

FIG. 13 is a side elevation view of the exemplary speaker.

FIG. 14 is an exploded view of the portable smart system and speaker.

Several embodiments in which the present invention can be practiced are illustrated and described in detail, wherein like reference characters represent like components throughout the several views. The drawings are presented for exemplary purposes and may not be to scale unless otherwise indicated.

### DETAILED DESCRIPTION OF THE INVENTION

The following definitions and introductory matters are provided to facilitate an understanding of the present invention. Unless defined otherwise, all technical and scientific terms used herein have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” as used herein are not intended to refer to any single embodiment of the particular invention but encompass all possible embodiments as described in the specification and the claims.

The term “about” as used herein refers to slight variations in numerical quantities with respect to any quantifiable variable. One of ordinary skill in the art will recognize inadvertent error can occur, for example, through use of typical measuring techniques or equipment or from differences in the manufacture, source, or purity of components. The claims include equivalents to the quantities whether or not modified by the term “about.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are referenced according to the views presented. Unless context indicates otherwise, these terms are not limiting.

Mechanical, electrical, chemical, procedural, and/or other changes apparent to one of ordinary skill in the art can be made without departing from the spirit and scope of the invention.

A smart device is an electronic device, generally connected to other devices or networks via different wireless protocols such as Bluetooth, Zigbee, NFC, Wi-Fi, Li-Fi, mobile or cellular telecommunications technology, etc., that can operate to some extent interactively and autonomously. Several notable types of smart devices are smartphones, smart cars, smart thermostats, smart doorbells, smart locks, smart refrigerators, phablets and tablets, smartwatches, smart bands, smart key chains, smart speakers, and others. The term can also refer to a device that exhibits some properties of ubiquitous computing, including—although not necessarily—artificial intelligence.

Smart devices are typically composed of a hardware layer (including a radio that transmits signals), a network layer (through which devices communicate with each other), and an application layer (through which end users deliver commands). These layers often include the following characteristics, a set of system hardware and software ICT resources—this set is usually static fixed at design time; dynamic component-oriented resource extensions and plug-ins (Plug and play) of some hardware resources; remote external service access and execution; local, internal autonomous service execution; access to specific external environments: human interaction, physical world interaction and distributed ICT/virtual computing interaction; and ubiquitous computing properties (processing units).

One example of a smart device is a smart speaker, which may be generally referred to as a type of wireless speaker and voice command device with an integrated virtual assistant that offers interactive actions and hands-free activation with the help of one “hot word” (or several “hot words”). Some smart speakers can also act as a smart device that utilizes Wi-Fi, Bluetooth and other wireless protocol standards to extend usage beyond audio playback, such as to control home automation devices. This can include, but is not limited to, features such as compatibility across a number of services and platforms, peer-to-peer connection through mesh networking, virtual assistants, and others. Each can have its own designated interface and features in-house, usually launched or controlled via application or home automation software. The smart speakers include one or more speakers for projecting audio as well as a user interface. The user interface may be a graphical or other interface that requires a touch to activate (e.g., a smart display), or may include one or more microphones wherein the user interface involves a “hot word” and/or command to operate. Examples of such smart speakers may include, but are not limited to, the Amazon Echo lineup (Echo, Dot, Plus, Show, Spot), Apple HomePod, Google Home series, Harman Kardon INVOKE, Galaxy Home Bixby, and the like.

One issue with at least some of the smart speakers, as well as other smart devices, is that they are limited in use by one or both of a tethered power source and the need for a network for the smart speaker/device to connect to be able to utilize the full functionalities of the device. For example, the device may require a wired plug-in for power. Other examples may require that the smart device requires a separate device to generate a wireless network that the smart device can connect, such as to be able to communicate with remote servers, satellites, other devices, or the like, in which one or more applications may reside. Such application can include, but are not limited to, weather reports, news, peer-to-peer communications, music, movies, audio books, games, and other general information.

Additional issues may include that the built-in speakers of the smart speakers or other devices may be insufficient for producing and/or projecting an adequate or otherwise desired audio output. This could be the level of sound, quality of sound, projection of sound in an area, acoustic resonance, clarity, accuracy, fidelity, or other output from the smart device. Thus, the smart device/speaker may be paired with another speaker system to enhance the audio output of the smart device/speaker. In such a situation, the smart speaker may be similar to a conduit or interface to connect to an application, such as a music source, and then to convey at least the audio output to the separate speaker. The connection between the smart device/speaker and the separate speaker can be wired or wirelessly, such as via WiFi, Bluetooth, near field communication (NFC), cellular or mobile communication, LAN, WAN, or the like. Such a connection may be referred to as “pairing” the smart device and the speaker.

Similar to that disclosed, there are limitations in that only one of the smart device or the speaker may be a mobile or portable device that is free from tethering (such as a wired power source). This limits the ability to use the devices in an on-the-go manner, or without a network projecting device (handheld, laptop, modem, router, server, cell phone, mobile hotspot, or the like). This creates a wireless tether that can limit the use of the portable speaker or smart device, such as in remote areas or times when a mobile hotspot is not available.

Therefore, according to any of the aspects and/or embodiments disclosed in the present disclosure, a portable system 10 provides for the portability of a smart device that untethers the smart device/speaker for greater use in more locations, such as remote locations, outdoor locations, or other situations in which a network or mobile hotspot is not available.

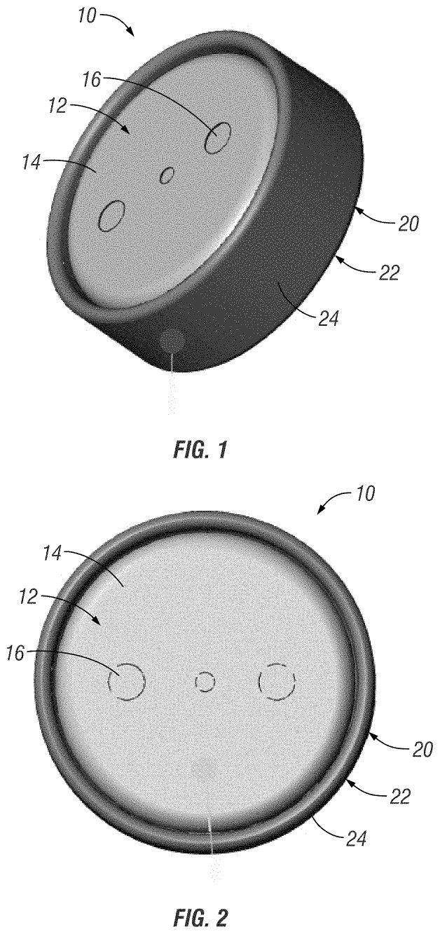

As shown in FIGS. 1-2, the portable system comprises a smart device 12 and a portable adapter or housing 20. The adapter 20 may also be referred to as a module, intermediary component, connector, or the like. As will be understood, the adapter 20 provides components, such as a portable power pack 27 and a wireless module 28, which creates a portable power source and network for the smart device 12 to connect, such as in a remote area or other area without a network to connect. Still further, it should be appreciated that the term “adapter” not mean that the housing is separate from the smart device 12. For example, the adapter or housing 20 may be integrally formed as part of the smart device, such that the smart device and adapter are not considered separate components, but are one in the same in that the components of the housing are part of the smart device. In such a situation, the smart device and housing/adapter may be referred to as a smart system 10.

The smart device 12 may be any smart device, such as those previously disclosed. However, for purposes of disclosure, the exemplary smart device 12 shown in the figures is a smart speaker 12, such as an Amazon Echo Dot™. It should be appreciated that this is not to be limiting on the disclosure, and generally any type, shape, brand, size, or otherwise for a smart speaker or device is contemplated to be utilized with any of the aspects of any of the embodiments disclosed herein. Still further, the term smart device should be considered to include the components of a smart device as has been included herein. The shape of the device, including the housing making up the smart system 10 can vary from that shown such that any shape, size, and/or orientation of components be included and considered as part of the present disclosure.

Accordingly, the smart speaker 12 shown in the figures includes a speaker housing 14 that houses the electronics, speakers, processors, memory, wireless modules (Bluetooth, Wi-Fi, NFC, cellular, or similar), and/or any ports (such as input and/or output I/O ports). The ports may include a power input, such as an auxiliary port or the like for connecting a power source. Traditionally, the port may be a wired power input connected to a power outlet or portable power source (i.e., a battery). In addition, it should be appreciated that the power source may be integral with the smart device, such as housed in the housing in the form of a rechargeable battery. There may still be a port for connecting to a battery charging cord, stand, or the like. Also shown in the figures is a user interface 16 for the smart speaker 12. The interface shown is in the form of buttons that are activated to access controls, such as sound controls (volume and/or mute), activation buttons, and/or buttons to activate the wireless connectivity features to connect to a network. Still other smart devices may include additional interfaces, such as graphical user interfaces, displays, and the like. Still further, the interface may include a microphone in the housing, in which a hot word or words activates the smart speaker/device, and additional voice inputs cause activation of the speaker. For example, the voice inputs may indicate the smart speaker to play a song, songs, playlist, station, radio station, news, weather, trivia, jokes, or other audio output, which is played through the speaker of the smart speaker. However, as disclosed, the size and capabilities of the speaker may be limited due to, in part, the size constraints of the smart speaker.

The adapter 20 is included to provide additional capabilities to the smart speaker 12. Such capabilities include, but are not limited to, portable power, portable network creation and/or connection, as well as a housing for connecting to/with or otherwise associating with a secondary output, such as a speaker 30.

FIGS. 1-2 show the smart speaker 12 housed within a portion of the housing 22 of the housing 20. While it is considered that a portion 22 of the housing 20 to substantially match or otherwise correspond with the size and shape of the smart device/speaker 12, this is not required for the adapter 20. The size and/or shape of any of the components may vary and are not to be limited to that shown. Still further, according to at least some embodiments and/or aspects of the disclosure, the adapter housing 22 includes a base 23 and upstanding wall 24, but this is also not required in all embodiments. Additional configurations may include, but are not limited to, a base for receiving a portion of the smart device, an extender or other shape that extends generally away from the smart device, or some combination thereof.

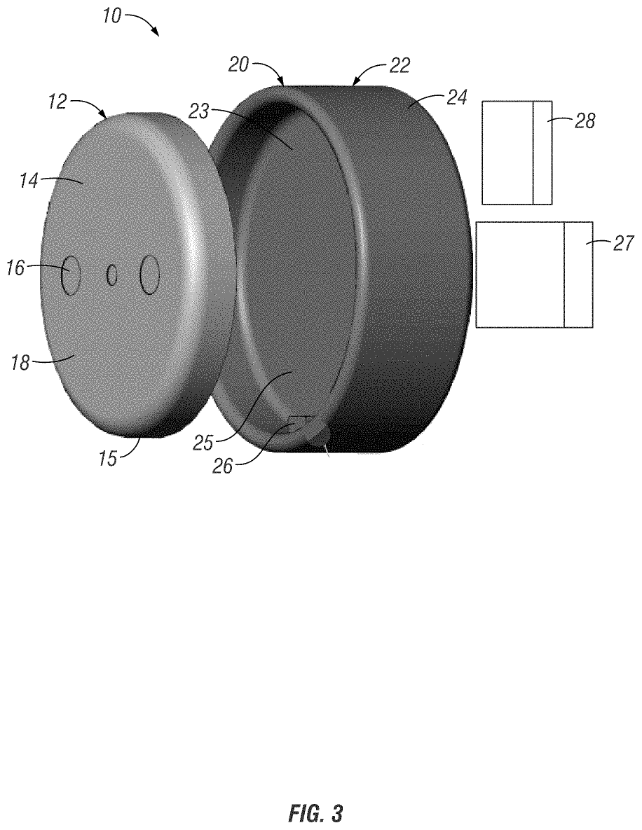

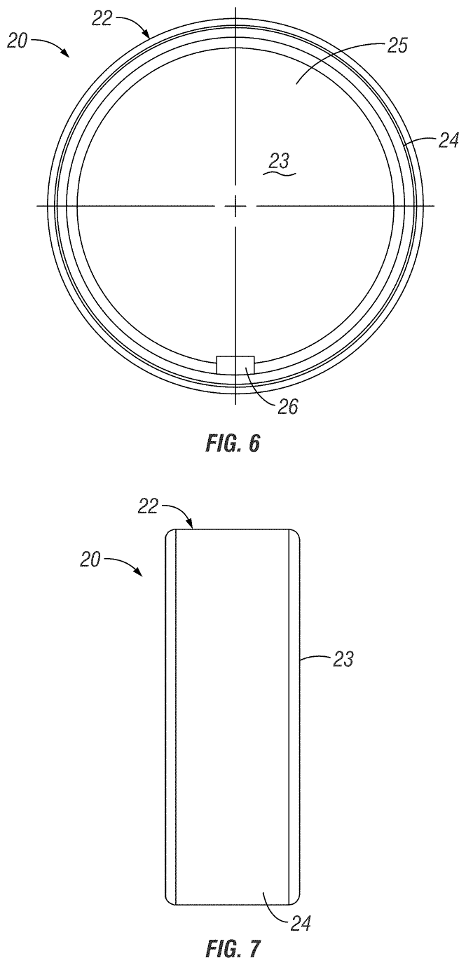

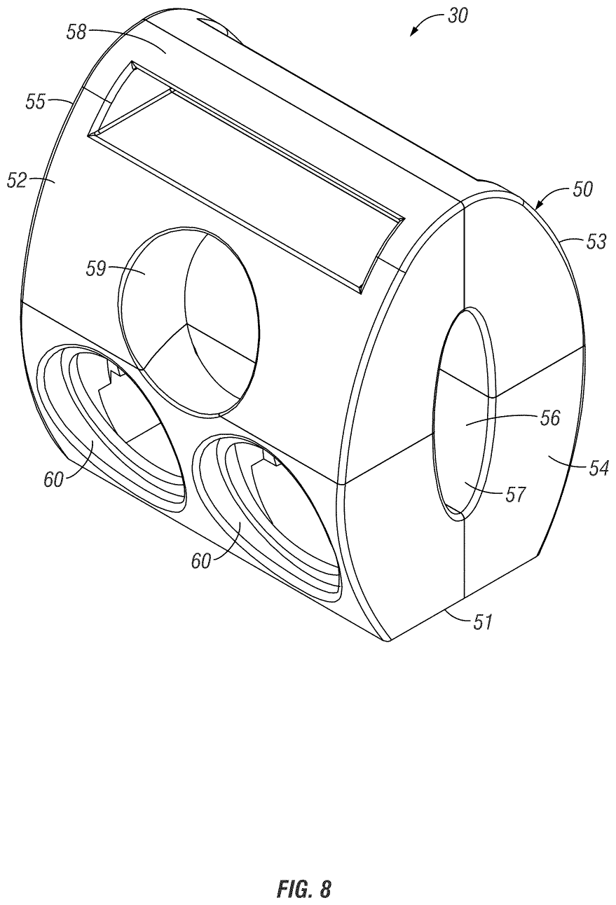

As shown in FIG. 3, according to some embodiments, the housing 22 of the adapter 20 includes a base 23 and upstanding wall 24 that form a recess 25. The smart device 12 is shown to fit generally within the recess 25, or a portion thereof. The housing 22 and adapter 20 are further shown in FIGS. 5-7, which show the adapter 20 without the smart device/speaker. Again, the housing 22 includes a base 23, which is shown to be circular in shape in the figures. However, as also included, the base and other components may take other shapes, such as those that generally correspond to the various shapes and sizes of a smart device. Still further, it should be appreciated that the base 23 take a form that corresponds to a shape of a reception area of a secondary element/speaker 30, and the upstanding wall(s) 24 of the adapter may be a different shape that corresponds to the smart device.

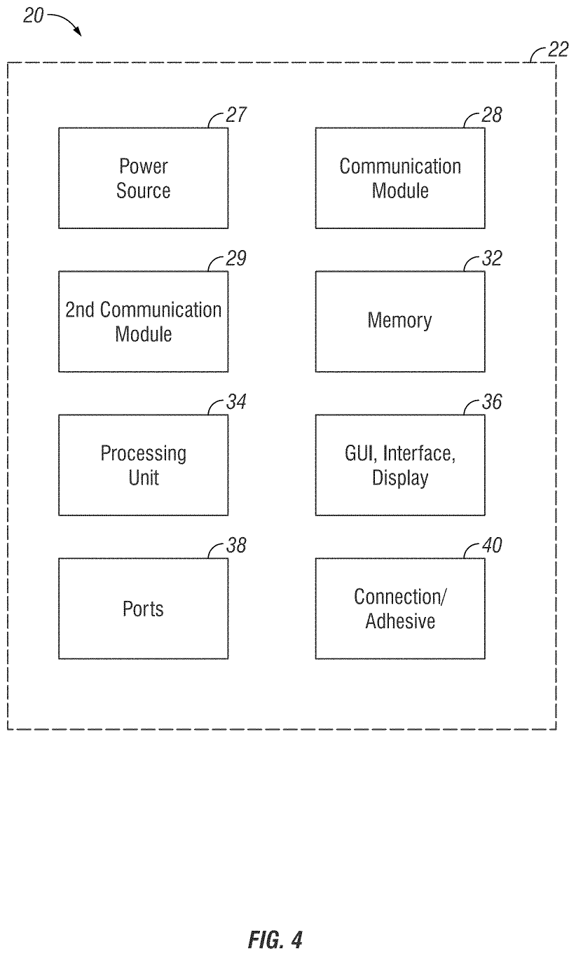

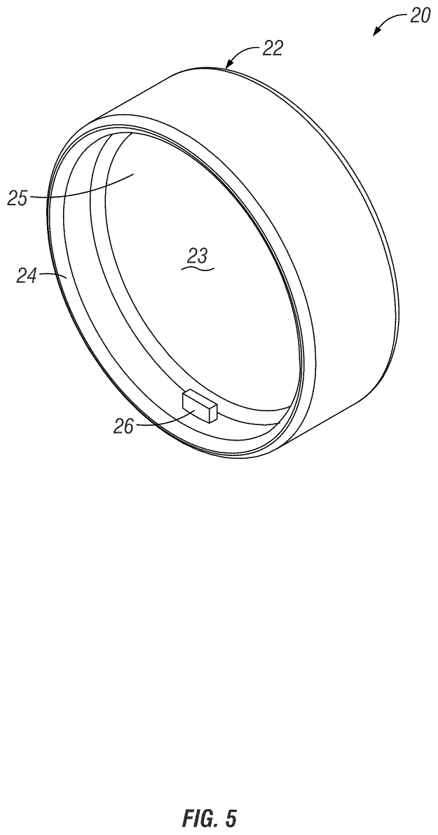

In addition, as noted, it should be appreciated that the adapter or housing 20 may be formed integrally with the smart device, such that the components of the adapter 20 (e.g., the components shown in FIG. 4) are integral with the smart device, making it an all-in-one smart system that includes features of the smart device plus additional components, such as power, cellular connectivity, etc.

As shown in the figures, the base 23 and upstanding wall 24 are generally circular, with the height of the wall being such that smart device is able to be received within a recess 25 formed by the base and wall. This is considered to be varied as needed. The housing comprises generally a rigid or semi-rigid material, such as, but not limited to, a plastic or thermoplastic, metal, rubber, silicone, or some combination thereof, such as with various components of the housing comprising the different materials.

In addition, as shown in FIGS. 3, 5, and 6, the adapter includes a connector or port 26. This connects the adapter 20, including at least some electronic or other components thereof, to the smart speaker. For example, the connector 26 may correspond to one or more input ports of the smart speaker, such as the power input, to provide portable power to the smart speaker 12. In addition, there could be a transmission of additional components, such as, but not limited to, electronic instructions, network connectability, processing power, data transmission, or the like.

The housing 22 of the adapter 20 is configured to house additional components, such as electronic components. These may include various modules, wires, and the like. The components may be housed in any portion of the housing 22, including the base 23 and/or wall(s) 24. FIG. 3 shows that the housing 22 includes a power module 27 and a communication module 28, but these are not to be limiting on the adapter.

FIG. 4 is a diagram showing additional components and/or modules that may be part of the adapter according to any of the aspects of any embodiment of the present disclosure. It should be appreciated that one or more of any of the components shown in FIG. 4 may be included, but not required. In addition, FIG. 4 shows the housing 22 in broken lines, indicating that there is no required or set shape, size, or configuration of a housing.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

As shown in FIG. 4, the adapter may include a power source 27. The power source 27 may be any power supply, such as an integrated power supply, which does not require a tether or wired connection to provide power. However, when a rechargeable power unit is used, there may be an external port for the adapter to provide external power for recharging the power source 27. The power supply outputs a particular voltage to a device or component or components of a device. The power supply could be a direct current (“DC”) power supply (e.g., a battery), an alternating current (“AC”) power supply, a linear regulator, etc. The power supply can be configured with a microcontroller to receive power from other grid-independent power sources, such as a generator or solar panel.

With respect to batteries, a dry cell battery may be used. Additionally, the battery may be rechargeable, such as a lead-acid battery, a low self-discharge nickel metal hydride battery (“LSD-NiMH”) battery, a nickel—cadmium battery (“NiCd”), a lithium-ion battery, or a lithium-ion polymer (“LiPo”) battery. Careful attention should be taken if using a lithium-ion battery or a LiPo battery to avoid the risk of unexpected ignition from the heat generated by the battery. While such incidents are rare, they can be minimized via appropriate design, installation, procedures and layers of safeguards such that the risk is acceptable.

The power supply could also be driven by a power generating system, such as a dynamo using a commutator or through electromagnetic induction. Electromagnetic induction eliminates the need for batteries or dynamo systems but requires a magnet to be placed on a moving component of the system.

The power supply may also include an emergency stop feature, also known as a “kill switch,” to shut off the machinery in an emergency or any other safety mechanisms known to prevent injury to users of the machine. The emergency stop feature or other safety mechanisms may need user input or may use automatic sensors to detect and determine when to take a specific course of action for safety purposes.

Additionally, the adapter 20 includes at least one wireless communication module 28 and can also include additional communication modules 29. The communication modules are provided to create a network for the smart speaker/device 12. In some embodiments, the network is, by way of example only, a wide area network (“WAN”) such as a TCP/IP based network or a mobile or cellular network, a local area network (“LAN”), a neighborhood area network (“NAN”), a home area network (“HAN”), or a personal area network (“PAN”) employing any of a variety of communication protocols, such as Wi-Fi, Bluetooth, ZigBee, near field communication (“NFC”), etc., although other types of networks are possible and are contemplated herein. The network typically allows communication between the communications module and the central location during moments of low-quality connections. Communications through the network can be protected using one or more encryption techniques, such as those techniques provided in the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like. According to at least some embodiments, the wireless module is a 4G LTE or 5G module for connecting to a cellular network.

The first and/or second communication module 28, 29 can also be used to connect to the smart speaker 12 and/or secondary output 30. In addition, additional wireless connection modules may be included to connect to the secondary output 30 or other devices. For example, the output may be a speaker system 30. A first wireless module 28 of the adapter 20 creates or otherwise connects to a network, such as a cellular network in a remote location. The smart speaker 20 connects to the cellular network to provide smart features and/or functionalities. The smart speaker can connect, either to the adapter or directly to the speaker 30 via the same cellular network or via a separate network, such as via Bluetooth, Airplay, NFC, or other wireless streaming protocol. Thus, the speaker 30 can be used to receive an output from the smart speaker 12 to enhance the audio output therefrom.

Additional aspects that may be included as part of the adapter 20 include a memory 32, processing unit(s) 34, display 36, and/or ports 38.

The memory includes, in some embodiments, a program storage area and/or data storage area. The memory can comprise read-only memory (“ROM”, an example of non-volatile memory, meaning it does not lose data when it is not connected to a power source) or random access memory (“RAM”, an example of volatile memory, meaning it will lose its data when not connected to a power source). Examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

In computing, a processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, and other computing devices capable of allowing input, providing options, and showing output of electronic functions.

The adapter 20 according to the aspects of the present disclosure may also include components such as an intelligent control (i.e., a controller) and communication components. Examples of such a controller may be processing units alone or other subcomponents of computing devices. The controller can also include other components and can be implemented partially or entirely on a semiconductor (e.g., a field-programmable gate array (“FPGA”)) chip, such as a chip developed through a register transfer level (“RTL”) design process.

A user interface is how the user interacts with a machine. While the smart device 12 may include its own user interface that is used when the device is combined with an adapter, according to some embodiments, such as when the smart device does not include an interface, the adapter could be provided with a user interface. The user interface can be a digital interface, a command-line interface, a graphical user interface (“GUI”) or any other way a user can interact with a machine. For example, the user interface (“UI”) can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, etc. Input(s) received from the UI can then be sent to a microcontroller to control operational aspects of a device.

The user interface module can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface also can be configured with a microcontroller to display conditions or data associated with the main device in real-time or substantially real-time. In some embodiments, the adapter 20 could include one or more communications ports such as Ethernet, serial advanced technology attachment (“SATA”), universal serial bus (“USB”), or integrated drive electronics (“IDE”), for transferring, receiving, or storing data. The ports could also be ports for an external power supply or charger, or even connecting to a secondary output 30, to transfer the audio and/or video from the smart device to the secondary output 30.

The adapter can be connected to or otherwise associated with a secondary output, such as a speaker, in a number of ways. There could be a fastener, adhesive, friction fit, knurl, seat, or the like. The adapter could be a separate component/system that is not attached to the secondary output, and may be positioned near or adjacent the output as well.

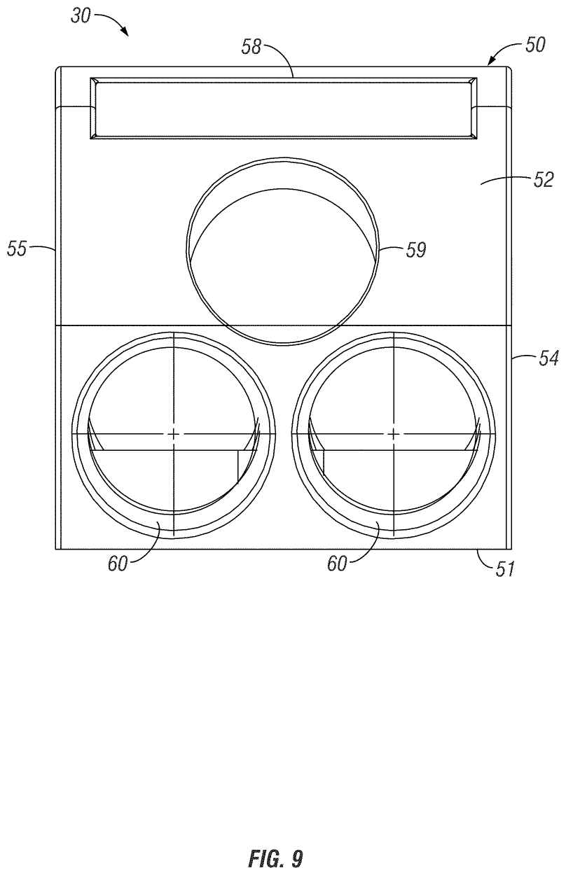

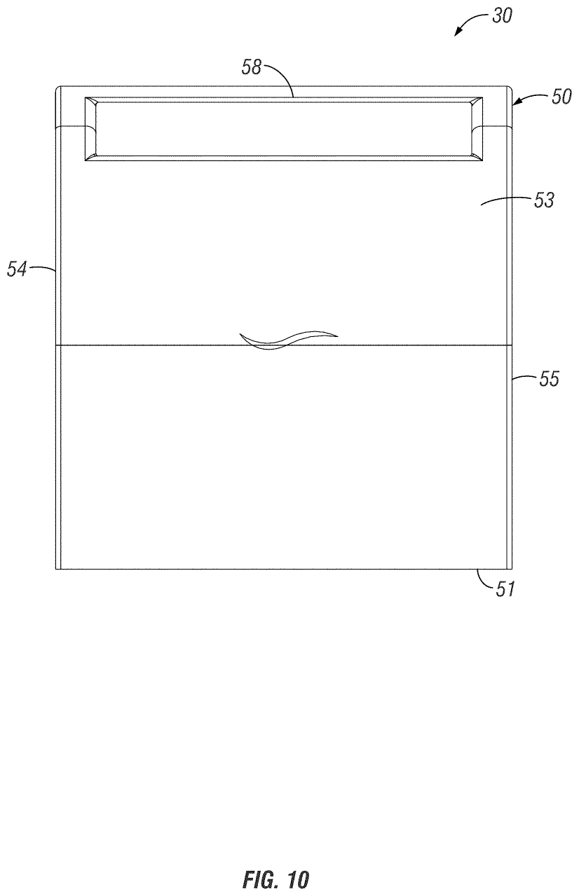

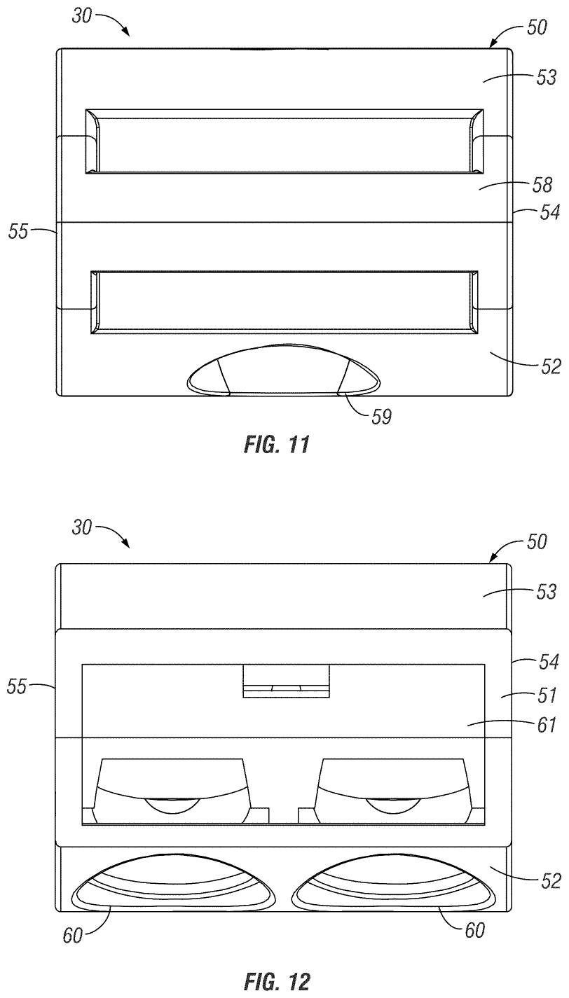

For exemplary purposes, the portable smart system 10 as shown and/or disclosed including the smart speaker 12 and adapter 20 can be used with a speaker system 30, such as shown in FIGS. 8-13. The speaker is provided for exemplary purposes, and any aspect of the speaker should not be limiting on the disclosure. According to some aspects, the speaker may include any or all features of the speaker system shown and described in U.S. Ser. No. 16/058,560, filed on Aug. 8, 2018, which is hereby incorporated by reference in its entirety.

As shown in FIGS. 8-13, the speaker 30 includes a housing 50. The speaker housing 50 includes the unique shape of the '560 application. As disclosed therein, rather than the typical rectangular, pill, or spherical shape, which requires the speakers to be on the outside and can result in inferior sound quality performance, this invention discloses a housing 50 with a form designed to hold at least one speaker inside the housing for a better sound distribution system. The housing 50 comprises a type of elongated tear drop shape. The housing includes a base 51, which may be planar, substantially planar, partially planar, or otherwise. For example, the base 51 is generally configured to be set on a surface, and the base can be shaped so as to provide a preferred stability for different surfaces. As shown best in the bottom view of FIG. 12, the base 51 may include a base cutout 61 that extends a distance inward. The cutout 61 may include forms for the speaker recesses, or may include openings at the speaker recesses, such that the speakers extend through and into the cutout 61. In addition, the base 51 may include gripping portions, such as rubber strips or the like to increase the friction coefficients between the base and any surface.

A first side portion 52 of the housing 50 extends generally upwardly from the base 51. The first side portion 52 includes, at a lower portion, external speaker openings 60A that are adapted to receive outward facing speakers. While two such openings 60A are shown, any number of openings may be provided. At an upper portion of the first or front wall 52 is an opening or recess 59 for receiving the adapter 20 or combined system 10 including the adapter 20 and smart speaker 12. As noted, the smart system 10 can be housed with, in, or to the speaker in a number of ways. For example, the adapter housing 22 or the all-in-one smart system 10 can be fit, such as friction fit, in or at least partially in the recess 59. An adhesive, such as glue, tape, hook and loops, snap, or the like could aid in holding, at least temporarily, the adapter to the speaker housing 50. In addition, it is noted that the front wall 52 of the speaker 30 is curved from the base towards the top. A handle recess 58 may be provided near the top edge of the first side portion 52 to facilitate carrying and placing a speaker system that uses the housing 50.

The rear wall 53 of the housing 50, shown throughout the figures, is of a similar upward extension and curvature as the front wall 52. The rear wall 53 also includes a handle portion 58 at or near the upper portion thereof.

The housing 50 may be formed from injection molded plastic pieces that snap together and may be secured with additional fasteners, such as threaded screws or the like in a known manner. For example, the housing may comprise, in some embodiments, four injected molded pieces that are put together. However, fewer or more components are also to be contemplated.

It is contemplated that the housing 50 can take a variety of different forms and is not limited to the raindrop or teardrop shape as shown in the figures. It is also contemplated that the housing can be made from a variety of materials or combination of materials. Exemplary examples include a type of wood or a thermoset plastic coated with rubber, but the housing material is not limited to these. Foams, rubbers, silicones (e.g., coatings), vinyl, leather, metals, or some combination of the same may be used. As will be understood, according to at least some aspects of the disclosure, the invention may be buoyant such that the material chosen allows for the speaker to float. Thus, it is further contemplated that the speaker housing comprises or otherwise be covered in a generally waterproof material. To aid in keeping the housing generally upright, a weight or weighted member may be included in a lower portion of the housing to maintain a desired orientation of the speaker or speaker housing system.

As shown throughout FIGS. 8-13, at opposite ends of the front and rear walls 52, 53 of the housing 50 is a first side wall 54 and a second side wall 55. The sidewalls 54, 55 are shown to be upward extending from the base and generally vertical (less curved or not curved at all). Extending through an interior of the speaker housing 50 from the first side wall 54 to the second side wall 55 is an acoustic tunnel 56. The acoustic tunnel is an oval, circular, or other geometrically shaped and hollow tunnel. The tunnel 56 comprises a wall 57, which separates the interior of the housing 50 that includes any electrical components or other components to remain hidden or out of sight in normal use, and an exterior of the housing, which may be in the tunnel itself. For example, if you were to place an object in the tunnel 56, it would be external to the housing interior, but inward of the sidewalls of the housing. Thus, wall 57 of the tunnel may be referred to as an exterior-type wall of the tunnel separating the interior and exterior of the housing 50.

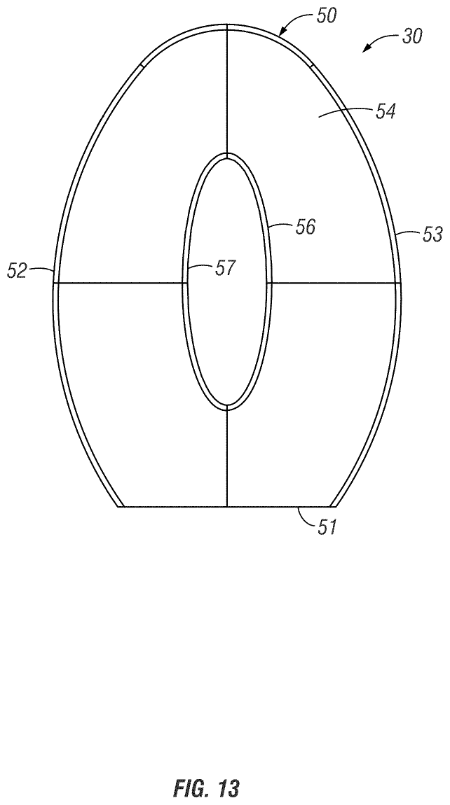

FIG. 13 is a side elevation view showing the first side wall 54 looking directly through the tunnel 56. In the embodiment shown, the tunnel 56 has an elliptical-shaped opening, and forms a generally elliptical right cylinder. This elliptical cross-section has been found desirable both in terms of sound quality and aesthetic appeal. Other cross-sectional shapes such as tear drop, egg, oval, or pear are also contemplated as well as other less symmetrical shapes.

The tunnel 56 may be formed by the shape of the housing 50 itself or may be a separate tube having the desired cross-sectional shape, effective diameter, and length. The effective diameter and length of the tube can be used to control the acoustic resonance of the tube in order to enhance and amplify desired sound frequencies. For example, it is noted that the invention may amplify the low frequency nodes and/or antinodes produced by the subwoofer output. The material of the tube or housing 50 may also affect the sound quality depending upon its sound reflecting and absorbing properties. The tube may also be chosen to have a different and complementary color as compared to the color of the housing 50 to provide a desired and aesthetically pleasing accent.

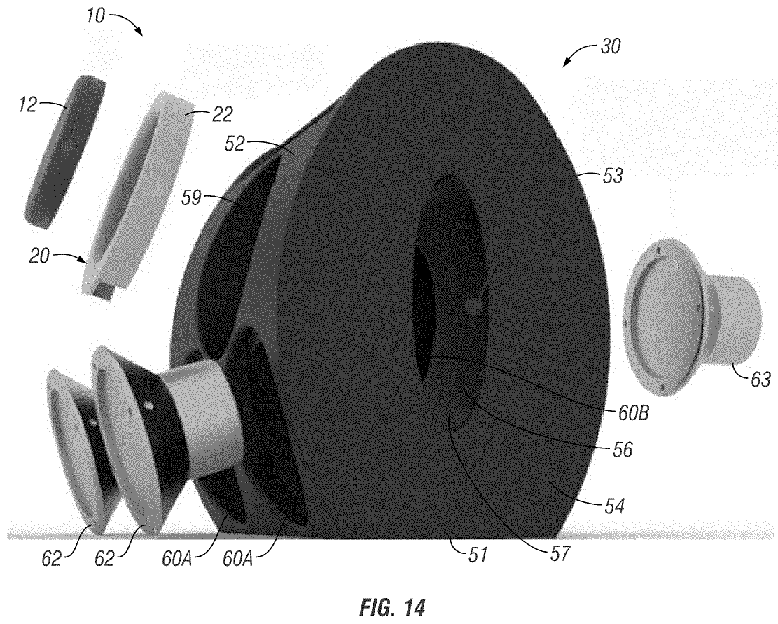

FIG. 14 is an exploded view of the exemplary speaker 30 as shown and described, including the portable system 10 including the adapter 20 and smart speaker 12. In addition, the figure shows exemplary speakers. As shown in FIG. 14, the smart speaker 12 is configured to be at least partially nested or seated in the housing 22 of the adapter 20. The smart system 10 is configured to be inserted, nested, seated, and/or otherwise positioned in the recess 59 at the upper portion of the front wall 52 of the speaker housing 50.

Still further, two speakers 62 are shown to be positioned in and through the front wall 52 at the speaker ports 60A. The speakers shown are 3-inch full range speakers, but any suitable speaker is considered. Still further, an inward facing speaker 63 is exploded from, but shown to be positioned in and through the wall 57 of the tunnel 56 at the speaker port 60B. The speaker is shown to be a 3-inch woofer, but other suitable speakers are considered. As noted, the cone of the speaker 63 is configured to be oriented into the tunnel through the wall 57, such that the sound from the speaker 63 will be directed into the tunnel, which creates an enhanced acoustic resonance.

While a particular and/or exemplary speaker has been shown and described, it should be appreciated that generally any type of speaker, and not the specific speaker shown, can be used with the portable system 10 comprising the smart device 12 and the adapter 20. For example, the connectivity of the smart device itself, or in conjunction with the adapter 20, allows for the portable system 10 to be connected to generally any external device (speaker, smart device, TV, computer, phone, handheld, or the like capable of being paired with a smart device in a wired or wireless manner.

The combination of the smart device 12 and the adapter 20 allows for an otherwise non-portable smart device to be utilized in an on-the-go manner, regardless of connectivity to a local network. Furthermore, as the adapter includes its own network module, the portable system 10 can be used without any external device, such as a cellular device, WiFi device, external speaker, power source, or the like.

It should be appreciated that the all-in-oneness of the portable system 10 allows the smart device to be used in many more locations than it otherwise would. This includes remote locations, such as camping, boating, on the water, biking, swimming, hiking, or in other circumstances where there is not a local network and where one may not wish to take their cellular or mobile phone. The adapter provides for a reduction of the number of devices needed, which is advantageous for on-the-go people who wish to take the bare minimum of equipment, but still wish to have some connectivity, such as for music, news, weather, or other information.

The present disclosure is not to be limited to the particular embodiments described herein. The scope of the invention is further qualified as including any possible combination of any of the aspects of any of the embodiments disclosed to result in additional embodiments, combinations, subcombinations, or the like that would be obvious to those skilled in the art.

1. A smart system, comprising:
a housing;
a smart device housed within the housing;
an integral, wireless power source associated with the housing, said integral power source providing power to the smart device; and
an integral, wireless communication module configured to create a network for the smart device to wirelessly connect.

2. The smart system of claim 1, wherein the integral, wireless communication module comprises a cellular data module or a WiFi module.

3. The smart system of claim 1, wherein the housing comprises a recessed portion for receiving at least a portion of the smart device.

4. The smart system of claim 1, further comprising a second wireless communication module for connecting to a secondary output.

5. The smart system of claim 4, wherein the second wireless communication module comprises a Bluetooth module.

6. The smart system of claim 4, wherein the secondary output comprises a speaker.

7. The smart system of claim 1, wherein the integral, wireless power source comprises a battery pack in which the battery pack may comprise a rechargeable battery.

8. The smart system of claim 7, wherein the housing comprises a microphone that allows a user to offer voice inputs.

9. A portable speaker and smart device system, comprising:
a speaker housing comprising at least one externally facing speaker, a substantially hollow tunnel extending through an exterior of the housing, and at least one speaker positioned to face into an exterior of the housing in the tunnel; and
an adapter operatively connected to the speaker housing and associated with the smart device, said adapter comprising:
a housing for receiving at least a portion of the smart device;
an integral, wireless power source, said integral power source providing power to the smart device; and
an integral, wireless communication module configured to create a network for the smart device to wirelessly connect.

10. The system of claim 9, wherein the speaker housing further comprises a recessed portion for receiving the adapter and smart device.

11. The system of claim 9, wherein the speaker housing further comprises a front and a rear wall that includes a handle portion located at or near the top of the front and/or rear wall.

12. The system of claim 11, wherein the front wall comprises one or more speaker ports and one or more additional speakers positioned in and through the front wall at the speaker ports.

13. The system of claim 9, wherein the speaker housing further comprises a base that includes gripping portions to increase the friction coefficients between the base and any surface upon which it rests.

14. The system of claim 9, wherein the speaker housing comprises an elongated tear drop shape.

15. The system of claim 9, wherein the tunnel has an elliptical-shaped opening and forms an elliptical cylinder.

16. The system of claim 9, wherein the at least one speaker positioned to face into an exterior of the housing in the tunnel creates an enhanced acoustic resonance.

17. The system of claim 9, wherein the speaker housing is buoyant and wherein the speaker housing further comprises or is otherwise covered in a waterproof material.

18. A method of manufacturing a portable speaker and smart device system comprising:
providing a speaker housing comprising at least one externally facing speaker, a substantially hollow tunnel extending through an exterior of the housing, and at least one speaker positioned to face into an exterior of the housing in the tunnel; and
operatively connecting an adapter to the speaker housing and associated with the smart device, said adapter comprising:
a housing for receiving at least a portion of the smart device;
an integral, wireless power source, said integral power source providing power to the smart device; and
an integral, wireless communication module configured to create a network for the smart device to wirelessly connect.

19. The method of claim 18 further comprising, placing at least a portion of the adapter and smart device in a recessed portion of the speaker housing.

20. The method of claim 18 further comprising, providing one or more speaker ports and one or more additional speakers positioned in and through a front wall of the speaker housing at the speaker ports.
